(19) United States
(12) Patent Application Publication
(10) Pub. No.: US 2026/0196429 A1
(43) Pub. Date: Jul. 9, 2026

(54) ELECTROMAGNET DEVICE

(71) Applicant: OMRON Corporation, Kyoto-shi, Kyoto (JP)

(72) Inventors: Hiroyuki TANAKA, Kyoto-shi, Kyoto (JP); Kazuya SODA, Kyoto-shi, Kyoto (JP); Sayaka TAJIRI, Kyoto-shi, Kyoto (JP); Takuya KOIZUMI, Kyoto-shi, Kyoto (JP); Masayuki NODA, Kyoto-shi, Kyoto (JP); Masatoshi NISHIDA, Kyoto-shi, Kyoto (JP); Akihiro OSAKO, Kyoto-shi, Kyoto (JP)

(21) Appl. No.: 19/134,223

(22) PCT Filed: Nov. 20, 2023
(86) PCT No.: PCT/JP2023/041580

§ 371 Date: May 30, 2025

(30) Foreign Application Priority Data
Dec. 15, 2022 (JP) 2022-200025

(51) Int. Cl. H01H 50/14

(52) U.S. Cl. CPC H01H 50/14

(57) ABSTRACT

An electromagnet device includes a coil, a spool, a first coil terminal, a second coil terminal, and a third coil terminal. The spool includes a body portion around which the coil is wound, and a flange portion. The first coil terminal includes a first tying portion extending from the flange portion in an axial direction of the body portion. The second coil terminal includes a second tying portion extending from the flange portion in the axial direction. The third coil terminal is disposed between the first and second coil terminals and includes a third tying portion including a base end portion and a distal portion extending from the base end portion in a direction approaching the second tying portion. The base end portion is disposed eccentrically relative to an axis of the body end portion in a direction from the second coil terminal toward the first coil terminal.

### CROSS-REFERENCE TO RELATED APPLICATIONS

This application is the U.S. National Phase of International Application No. PCT/JP2023/041580, filed on Nov. 20, 2023. That application claims priority to Japanese Patent Application No. 2022-200025, filed Dec. 15, 2022. The contents of those two applications are incorporated by reference herein in their entireties.

### FIELD

The claimed invention relates to an electromagnet device.

### BACKGROUND

Japanese Patent Application Publication No. 2015-041608 discloses a two-winding latching-type electromagnetic relay. The electromagnetic relay includes an electromagnet device. The electromagnet device includes three coil terminals arranged in the same direction. Each of the three coil terminals includes a tying portion to which a lead wire of the coil is connected. Among the three coil terminals, the tying portion of the center coil terminal has a bent portion extending in the direction in which the three coil terminals are arranged.

In the electromagnet device disclosed in Japanese Patent Application Publication No. 2015-041608, the tying portion of the center coil terminal is bent in the direction in which the three coil terminals are arranged. As a result, the insulation distances between the center coil terminal and the coil terminals located close to the tying portion of the center terminal are reduced. If adequate insulation distance between the center coil terminal and the terminals close to the tying portion of the center coil terminal is to be ensured, the electromagnet device may be increased in size.

### SUMMARY

An object of the claimed invention is to provide an electromagnet device in which adequate insulation distances between coil terminals are ensured while the overall size of the electromagnet device is kept from increasing.

An electromagnet device according to one aspect of the claimed invention includes a coil, a spool, a first coil terminal, a second coil terminal, and a third coil terminal. The spool includes a body portion on which the coil is wound, and a flange portion extending from the body portion. The first coil terminal includes a first tying portion extending from the flange portion in an axial direction of the body portion. The second coil terminal includes a second tying portion extending from the flange portion in the axial direction. The third coil terminal is disposed between the first coil terminal and the second coil terminal. The third coil terminal includes a third tying portion. The third tying portion includes a base end portion and a distal portion extending from the base end portion in a direction approaching the second tying portion. The base end portion of the third tying portion is disposed eccentrically relative to an axis of the body portion in a direction from the second coil terminal toward the first coil terminal.

In this electromagnet device, the base end portion of the third tying portion is disposed eccentrically relative to the axis of the body portion in the direction from the second coil terminal toward the first coil terminal, which facilitates ensuring an insulation distance between the third tying portion and the second tying portion. As a result, it is possible to maintain adequate insulation distance between coil terminals while restraining the overall size of the electromagnet device from increasing. In addition, the first, second, and third coil terminals can be constructed using a common terminal, which promotes component commonality.

The third tying portion may have a length dimension substantially equal to a length dimension of the first entanglement portion and a length dimension of the second entanglement portion. In this case, the first tying portion 71a, the second tying portion 72a, and the third tying portion 73a can be soldered simultaneously using a jig.

The flange portion of the spool may include a terminal support portion configured to support the third coil terminal and a protrusion facing the terminal support portion in the axial direction, the protrusion being configured to hook a lead wire of the coil thereon. The third tying portion of the third coil terminal may be disposed between the terminal support portion and the protrusion. In this case, when assembling the electromagnet device, the lead wire of the coil is engaged with the protrusion to prevent the lead wire from breaking due to the tension generated in the lead wire when the third tying portion is bent back after soldering the third tying portion.

during assembly of the electromagnet device, the lead wire may be temporarily held by the protrusion. Accordingly, when the third tying portion is soldered and subsequently bent back, the lead wire is unlikely to be subjected to tension, thereby reducing the risk of disconnection of the lead wire.

The distance from the base end portion of the third tying portion to the first tying portion may be substantially equal to the distance from the tip of the distal portion of the third tying portion to the second tying portion. In this case, the insulation distance between coil terminals can be efficiently secured within a limited space.

The electromagnet device may further include an insulating wall disposed at least one between the first and third tying portions or between the second and third tying portions. In this case, the insulating wall enhances the insulation performance between the coil terminals.

The second coil terminal may have the same shape as the first coil terminal. The third coil terminal may a terminal formed by bending a terminal having the same shape as the first coil terminal. In this case, all three coil terminals can be constructed using a common terminal, which promotes component commonality.

### BRIEF DESCRIPTION OF THE DRAWINGS

FIG. 1 is a side view of an electromagnetic relay.

FIG. 2 is a left side view of an electromagnet device.

FIG. 3 is a diagram illustrating the operating state of an electromagnet device.

FIG. 4 is a diagram illustrating an assembly procedure of an electromagnet device.

FIG. 5 is a diagram illustrating an assembly procedure of an electromagnet device.

FIG. 6 is a diagram illustrating an assembly procedure of an electromagnet device.

FIG. 7 is a diagram illustrating an assembly procedure of an electromagnet device.

FIG. 8 is a left side view of an electromagnet device according to a modification.

FIG. 9 is a diagram illustrating a modification of a protrusion.

FIG. 10 is a diagram illustrating a modification of a protrusion.

FIG. 11 is a diagram illustrating a modification of a protrusion.

### DETAILED DESCRIPTION

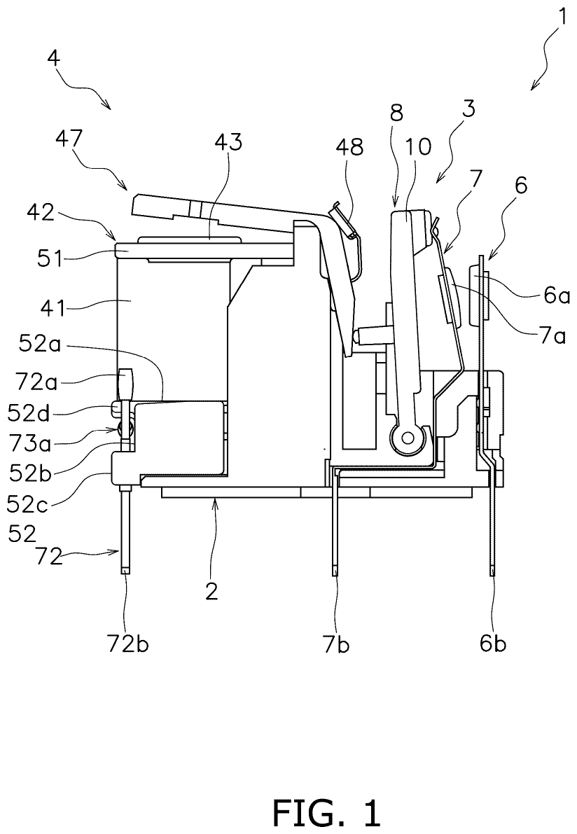

Hereinafter, an embodiment of an electromagnetic relay that includes an electromagnet device according to one aspect of the claimed invention will be described with reference to the drawings. For ease of description when referring to the drawings, the upper side in FIG. 1 will be referred to as “upper,” the lower side as “lower,” the left side as “left,” the right side as “right,” the near side of the sheet as “front,” and the far side as “rear.” These directions are defined for convenience of description, and do not limit the arrangement directions of the electromagnetic relay.

The electromagnetic relay 1 is a hinge-type electromagnetic relay. The electromagnetic relay 1 is a two-winding latching-type electromagnetic relay. As illustrated in FIG. 1, the electromagnetic relay 1 includes a base 2, a contact device 3, and an electromagnet device 4. The base 2 is comprised of insulating material such as resin. A box-shaped cover member (not shown) is disposed above the base 2. The contact device 3 and the electromagnet device 4 are disposed in an internal space formed by the base 2 and the cover member.

The contact device 3 includes a fixed terminal 6, a movable contact piece 7, and an actuating mechanism 8. The fixed terminal 6 and the movable contact piece 7 are plate terminals and are comprised of conductive material. The fixed terminal 6 and the movable contact piece 7 are supported by the base 2. The fixed terminal 6 and the movable contact piece 7 extend upward from the base 2.

The fixed terminal 6 includes a fixed contact 6a and an external connection portion 6b. The fixed contact 6a is disposed above the base 2. The fixed contact 6a is located on the right surface of the fixed terminal 6.

The external connection portion 6b protrudes downward from the base 2 and is exposed to the outside. The external connection portion 6b is to be electrically connected to an external device (not shown).

The movable contact piece 7 is formed of an elastically deformable leaf spring and is arranged opposite the fixed terminal 6 in the left-right direction. In the present embodiment, the movable contact piece 7 is disposed to the left of the fixed terminal 6.

The movable contact piece 7 includes a movable contact 7a and an external connection portion 7b. The movable contact 7a is arranged opposite the fixed contact 6a and is configured to come into contact with the fixed contact 6a. The external connection portion 7b is to be electrically connected to an external device (not shown).

The actuating mechanism 8 moves the movable contact piece 7 in a direction in which the movable contact 7a approaches the fixed contact 6a and in a direction in which the movable contact 7a separates from the fixed contact 6a. In the present embodiment, the movement directions of the movable contact piece 7 correspond to the left-right direction.

The actuating mechanism 8 includes a card 10. The card 10 is rotatably supported by the base 2. The card 10 is rotatable in the left-right direction with the lower end of the card 10 serving as a pivot. The card 10 is disposed between the movable contact piece 7 and the electromagnet device 4. The card 10 is connected to both the movable contact piece 7 and the electromagnet device 4.

The electromagnet device 4 uses electromagnetic force to move the movable contact piece 7 via the actuating mechanism 8. The electromagnet device 4 rotates the card 10 by electromagnetic force, thereby moving the movable contact piece 7 in the left-right direction.

As illustrated in FIGS. 1 to 3, the electromagnet device 4 includes a coil 41, a spool 42, an iron core 43, a yoke 44, an auxiliary yoke 45, a permanent magnet 46, a movable iron piece 47, and a hinge spring 48.

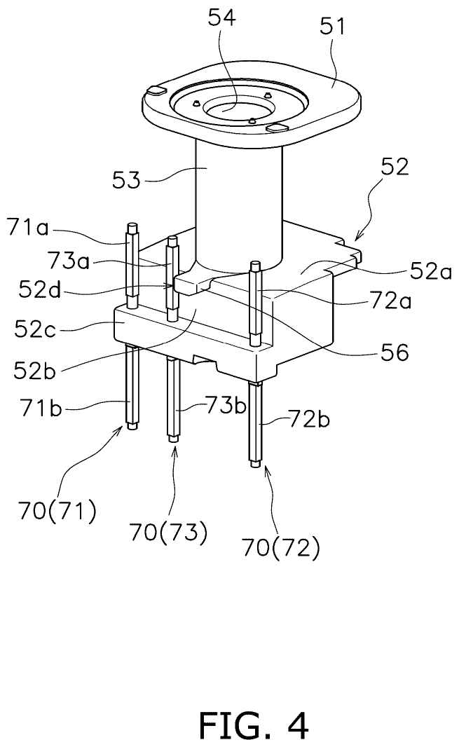

The coil 41 is wound around the outer circumference of the spool 42. The spool 42 extends in the up-down direction. The axial direction of the spool 42 corresponds to the up-down direction. As illustrated in FIG. 4, the spool 42 includes a first flange 51, a second flange 52 (an example of the flange portion), a body portion 53, and a housing portion 54.

The first flange 51 and the second flange 52 protrude from the body portion 53. The first flange 51 is connected to an upper end of the body portion 53. The second flange 52 is connected to a lower end of the body portion 53. The first flange 51 and the second flange 52 extend in a direction intersecting the up-down direction. The first flange 51 and the second flange 52 each have an outer diameter greater than the outer diameter of the body portion 53.

The second flange 52 includes an upper surface portion 52a, a side wall 52b, a terminal support portion 52c, and a protrusion 52d. The upper surface portion 52a is disposed below the coil 41. The side wall 52b extends downward from a left end of the upper surface portion 52a. The side wall 52b is positioned between the upper surface portion 52a and the terminal support portion 52c. The terminal support portion 52c protrudes leftward from a lower end of the side wall 52b. The terminal support portion 52c extends in a front-rear direction.

The protrusion 52d is disposed above the terminal support portion 52c. The protrusion 52d is arranged opposite the terminal support portion 52c in the up-down direction. The protrusion 52d is configured to hook the lead wire of the coil 41 thereon. The protrusion 52d protrudes leftward from the side wall 52b. The protrusion 52d is adjacent to the upper surface portion 52a. When viewed from the left-right direction, the protrusion 52d is positioned to overlap the axis A of the body portion 53.

The protrusion 52d includes a first surface 56 and an inclined surface 57 connected to the first surface 56. The first surface 56 is a front surface of the protrusion 52d. The first surface 56 is situated forward of the axis A of the body portion 53. The inclined surface 57 extends rearward and downward from a lower end of the first surface 56.

The body portion 53 has a cylindrical shape and has the coil 41 wound around its outer periphery. The body portion 53 extends in the up-down direction. The axial direction of the body portion 53 corresponds to the up-down direction.

The housing portion 54 is located in the body portion 53. The housing portion 54 is a circular hole when viewed from the up-down direction. The housing portion 54 is formed to penetrate through a central portion of the body portion 53 in the up-down direction.

The iron core 43 is arranged inside the spool 42. The iron core 43 is housed in the housing portion 54. The iron core 43 is connected to a yoke 44. The axis of the iron core 43 extends in the up-down direction.

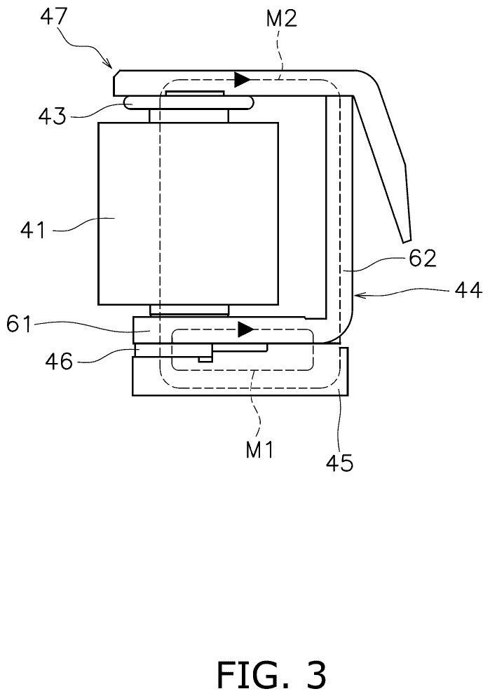

As illustrated in FIG. 3, the yoke 44 is connected to the iron core 43, the auxiliary yoke 45, and the permanent magnet 46. The yoke 44 has a bent L-shaped configuration. The yoke 44 rotatably supports the movable iron piece 47. It should be noted that the spool 42 is omitted from the illustration in FIG. 3.

The yoke 44 includes a base portion 61 and an extension portion 62. The base portion 61 is disposed below the second flange 52. The base portion 61 is fixed to a lower end of the iron core 43. The extension portion 62 bends from a right end of the base portion 61 and extends upward. The extension portion 62 is positioned to the right side of the coil 41.

The auxiliary yoke 45 is disposed below the base portion 61 of the yoke 44. The auxiliary yoke 45 is located between the base portion 61 of the yoke 44 and a base 2 in the up-down direction.

The permanent magnet 46 is disposed between the base portion 61 of the yoke 44 and the auxiliary yoke 45. The upper surface of the permanent magnet 46 is in contact with the yoke 44. The lower surface of the permanent magnet 46 is in contact with the auxiliary yoke 45.

The movable iron piece 47 is rotatably supported by the extension portion 62 of the yoke 44 via the hinge spring 48. The movable iron piece 47 is rotatable between a first position shown in FIG. 1 and a second position shown in FIG. 3. In the first position, the movable iron piece 47 is separated away from the iron core 43. In the second position, the movable iron piece 47 is in contact with the iron core 43. The second position corresponds to the operating position of the movable iron piece 47.

The hinge spring 48 is fixed to the extension portion 62 of the yoke 44. The hinge spring 48 is mounted to the extension portion 62 of the yoke 44 to hold the movable iron piece 47.

Next, the operation of the electromagnetic relay 1 will be described. The operation of the electromagnetic relay 1 is the same as that of a conventional electromagnetic relay; therefore, it will be described briefly. While no voltage is applied to the coil 41, the movable iron piece 47 is positioned in the first position due to the elastic force of a movable contact piece 7, and the movable contact 7a is separated from the fixed contact 6a. In this state, a magnetic circuit M1 is formed to pass through the auxiliary yoke 45 and the base portion 61 of the yoke 44, and a magnetic circuit M2 is formed to pass through the iron core 43, the movable iron piece 47, the yoke 44, and the auxiliary yoke 45, due to the magnetic flux from the permanent magnet 46.

When a voltage is applied to the coil 41 such that a magnetic flux is generated in the same direction as the magnetic flux flowing through the magnetic circuit M2, a magnetic circuit is formed through the iron core 43, the movable iron piece 47, and the yoke 44 by the magnetic flux generated due to the voltage applied to the coil 41. As a result, the attractive force of the iron core 43 on the movable iron piece 47 increases, causing the movable iron piece 47 to rotate and move from the first position to the second position. As the movable iron piece 47 moves from the first position to the second position, the card 10 is pressed by the movable iron piece 47, and the movable contact 7a comes into contact with the fixed contact 6a.

Even after the voltage applied to the coil 41 is stopped, the magnetic force of the magnetic circuit M2 is greater than the elastic force of the movable contact piece 7. As a result, the movable iron piece 47 is maintained at the second position.

When a return voltage is applied to the coil 41 in the direction opposite to the applied voltage so as to cancel the magnetic force of the magnetic circuit M2, the movable iron piece 47 moves from the second position to the first position, and the movable contact 7a separates from the fixed contact 6a.

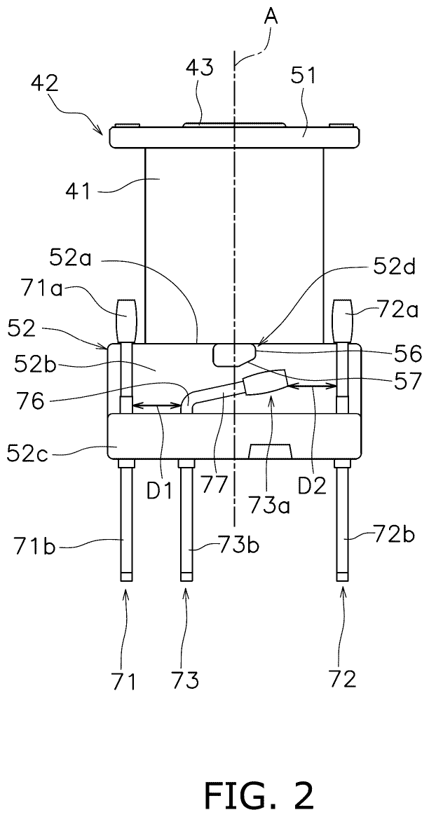

As illustrated in FIG. 2, the electromagnet device 4 includes a first coil terminal 71, a second coil terminal 72, and a third coil terminal 73. The first to third coil terminals 71 to 73 are arranged in line in one direction (here, the front-rear direction). These coil terminals 71 to 73 are supported by the terminal support portion 52c. The terminal support portion 52c has holes into which the first to third coil terminals 71 to 73 are inserted respectively.

The first coil terminal 71 is disposed near the rear end of the terminal support portion 52c. The first coil terminal 71 is positioned rearward of the axis A of the body portion 53. The first coil terminal 71 is also situated rearward of the coil 41. The first coil terminal 71 extends in the up-down direction.

The first coil terminal 71 includes a first tying portion 71a and a first external connection portion 71b. The first tying portion 71a is connected to a lead wire of the coil 41. The first tying portion 71a extends in the up-down direction. The first tying portion 7la protrudes upward from the terminal support portion 52c. The first external connection portion 71b protrudes downward from the terminal support portion 52c and is exposed to the outside.

The second coil terminal 72 has the same shape as the first coil terminal 71; that is, the second coil terminal 72 is formed using a terminal common to the first coil terminal 71. The second coil terminal 72 is disposed near the front end of the terminal support portion 52c. The second coil terminal 72 is situated forward of the axis A of the body portion 53. The second coil terminal 72 is situated forward of the coil 41. The second coil terminal 72 also extends in the up-down direction.

The second coil terminal 72 includes a second tying portion 72a and a second external connection portion 72b. The second tying portion 72a is connected to a lead wire of the coil 41. The second tying portion 72a extends in the up-down direction. The second tying portion 72a protrudes upward from the terminal support portion 52c. The second external connection portion 72b protrudes downward from the terminal support portion 52c and is exposed to the outside.

The third coil terminal 73 is disposed between the first coil terminal 71 and the second coil terminal 72. As illustrated in FIG. 2, the third coil terminal 73 is disposed eccentrically relative to the axis A of the body portion 53 in a direction from the second coil terminal 72 toward the first coil terminal 71 (here, rearward). When viewed from the left-right direction, the third coil terminal 73 is located between the first coil terminal 71 and the axis A of the body portion 53.

The third coil terminal 73 includes a third tying portion 73a and a third external connection portion 73b. The third tying portion 73a is connected to a lead wire of the coil 41. The third tying portion 73a protrudes upward from the terminal support portion 52c. The third tying portion 73a has a bent shape, and the bent portion extends in a direction approaching the second tying portion 72a (here, forward). The third tying portion 73a is positioned between the terminal support portion 52c and the protrusion 52d. In the present embodiment, the third coil terminal 73 is formed by bending a terminal of the same shape as the first coil terminal 71. That is, the third coil terminal 73 is formed using a terminal common to the first coil terminal 71.

The third tying portion 73a includes a base end portion 76 and a distal portion 77. The base end portion 76 protrudes upward from the terminal support portion 52c. The base end portion 76 is disposed eccentrically relative to the axis A of the body portion 53 in the direction from the second coil terminal 72 toward the first coil terminal 71. The base end portion 76 is located closer to the first tying portion 71a than to the second tying portion 72a. The base end portion 76 is located behind of the protrusion 52d. The base end portion 76 located behind the axis A of the body portion 53.

The distal portion 77 extends from the base end portion 76 in a direction approaching the second tying portion 72a. The distal portion 77 is located closer to the second tying portion 72a than to the first tying portion 71a. The distal portion 77 extends forward beyond the protrusion 52d. That is, the tip of the distal portion 77 is situated forward of the protrusion 52d. The distal portion 77 is spaced apart from the terminal support portion 52c in the up-down direction. The distal portion 77 is located closer to the protrusion 52d than the base end portion 76. The distal portion 77 inclines in a direction approaching the protrusion 52d toward the front. The third external connection portion 73b protrudes downward from the terminal support portion 52c and is exposed to the outside. The third external connection portion 73b is disposed eccentrically relative to the axis A of the body portion 53 in the direction from the second coil terminal 72 toward the first coil terminal 71.

The third tying portion 73a has substantially the same length as those of the first tying portion 71a and the second tying portion 72a. The length of the first tying portion 71a refers to its dimension in the extending direction, which corresponds to the dimension in the up-down direction of the first tying portion 71a in the present embodiment. The length dimension of the second tying portion 72a refers to its dimension in the extending direction, and in the present embodiment, corresponds to the dimension in the up-down direction of the second tying portion 72a. The length dimension of the first tying portion 71a is the same as that of the second tying portion 72a. The length dimension of the third tying portion 73a refers to the dimension from the base end portion 76 to the tip of the distal portion 77.

As illustrated in FIG. 2, in the present embodiment, the distance D1 from the base end portion 76 of the third tying portion 73a to the first tying portion 71a is substantially equal to the distance D2 from the tip of the distal portion 77 of the third tying portion 73a to the second tying portion 72a. It should be noted that the distances D1 and D2 need not be substantially equal. For example, the distance D1 may be longer than the distance D2.

Next, an example of a method for assembling the electromagnet device 4 will be described. As illustrated in FIG. 4, three coil terminals 70 having the same shape as the spool 42 are prepared, and the three coil terminals 70 are fixed to the terminal support portion 52c, for example by press-fitting. The leftmost coil terminal 70 corresponds to the first coil terminal 71, the rightmost corresponds to the second coil terminal 72, and the center one corresponds to the third coil terminal 73. At this stage, the tying portion 73a of the third coil terminal 73 extends in the same direction as the first and second tying portions 71a and 72a.

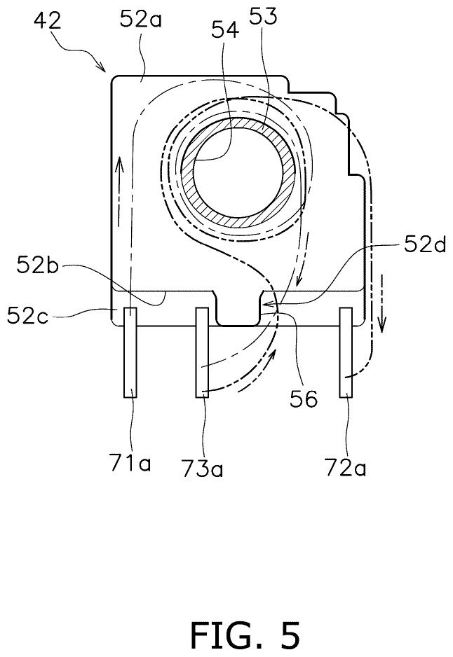

Next, as illustrated in FIG. 5, the tying portions (first to third tying portions 71a, 72a, 73a) of the three coil terminals 70 (first to third coil terminals 71 to 73) are bent in the same direction. In the present embodiment, the tying portions are each bent approximately 90° in the direction opposite the side wall 52b. Then, one lead wire (indicated by a one-dot chain line) of the first winding of the coil 41 is wound around the first tying portion 71a, and the winding is wound a predetermined amount clockwise around the body portion 53. Subsequently, the other lead wire of the first winding is pulled out so as to hook onto the front surface of the protrusion 52d and connected to the third tying portion 73a.

Next, one lead wire of the second winding of the coil 41 (indicated by a two-dot chain line) is connected to the third tying portion 73a. Then, the other lead wire of the second winding is pulled out so as to hook onto the front surface of the protrusion 52d, and the winding is wound clockwise around the body portion 53 a predetermined amount. Finally, the other lead wire of the second winding is connected to the second tying portion 72a.

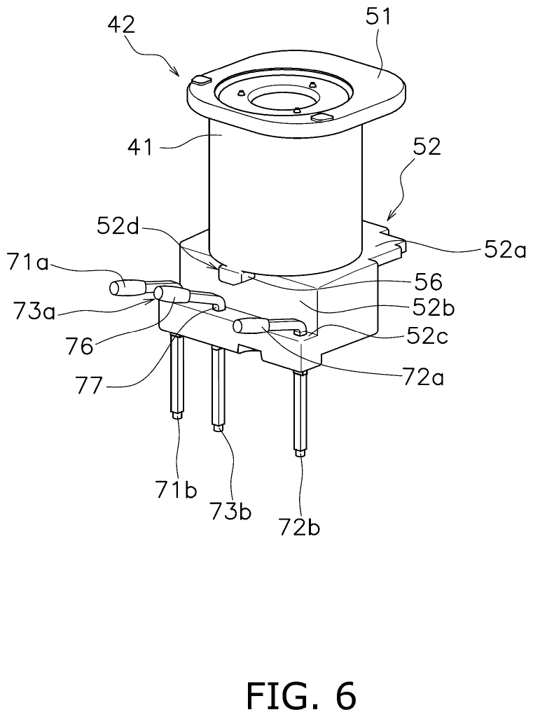

Next, as illustrated in FIG. 6, the first tying portion 71a, second tying portion 72a, and third tying portion 73a are soldered.

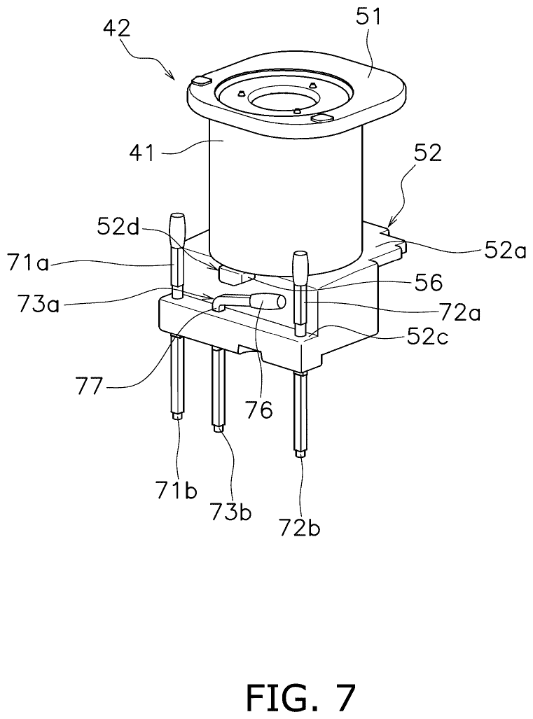

Subsequently, as illustrated in FIG. 7, the first and second tying portions 71a and 72a are bent back to the positions illustrated in FIG. 4. The third tying portion 73a is rotated 90° horizontally and placed between the protrusion 52d and the terminal support portion 52c. The lead wire connected to the third tying portion 73a is arranged to hook onto the front surface of the protrusion 52d. Therefore, when the third tying portion 73a is rotated 90° horizontally and placed between the protrusion 52d and the terminal support portion 52c, the lead wire is unlikely to be subjected to tension, reducing the risk of disconnection of the lead wire. It should be noted that in FIGS. 6 and 7, the lead wires are omitted for clarity.

In the electromagnet device 4 of the electromagnetic relay 1 described above, the base end portion 76 of the third tying portion 73a of the third coil terminal 73 is disposed eccentrically in the direction from the second coil terminal 72 toward the first coil terminal 71 relative to the axis A of the body portion 53. This configuration facilitates ensuring insulation distance between the third tying portion 73a of the third coil terminal 73 and the second tying portion 72a of the second coil terminal 72. With this configuration, it is possible to secure insulation distances between the first and third coil terminals 71 and 73 and between the second and third coil terminals 72 and 73, while keeping the size of the electromagnet device 4 from increasing. In addition, since the first, second, and third coil terminals 71 to 73 can be formed using a common terminal, component commonality can be achieved.

One embodiment of the electromagnetic relay according to one aspect of the claimed invention has been described above. The claimed invention, however, is not limited to the above embodiment, and various changes can be made without departing from the scope of the claimed invention.

In the above embodiment, the first coil terminal 71 is disposed near the rear end of the terminal support portion 52c, and the second coil terminal 72 is disposed near the front end of the terminal support portion 52c. However, the positions of the first coil terminal 71 and the second coil terminal 72 may be reversed. In this case, the third coil terminal 73 is disposed eccentrically forward relative to the axis A of the body portion 53 of the spool 42.

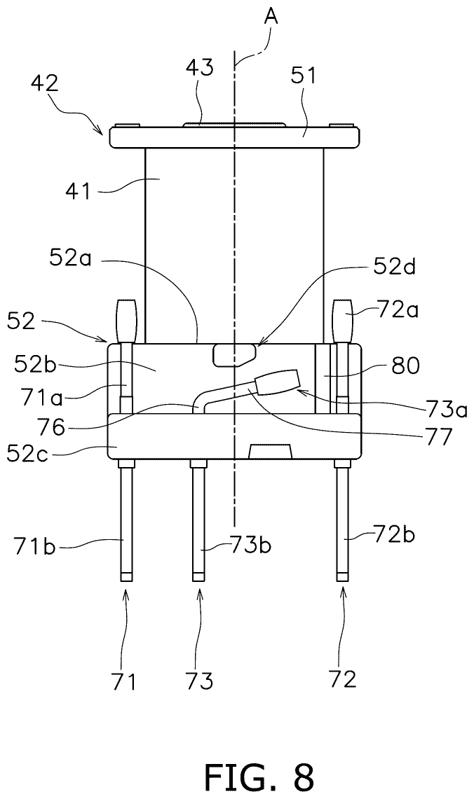

FIG. 8 is a left side view of an electromagnet device 4 according to a modification. The electromagnet device 4 further includes an insulating wall 80. The insulating wall 80 is disposed between the first tying portion 71a and the third tying portion 73a. The insulating wall 80 is formed integrally with the spool 42. The insulating wall 80 extends in a direction intersecting the left-right direction. The insulating wall 80 protrudes upward from the terminal support portion 52c to connect to the side wall 52b. The insulating wall 80 may alternatively be a separate member from the spool 42. The insulating wall 80 may also be disposed between the second tying portion 72a and the third tying portion 73a.

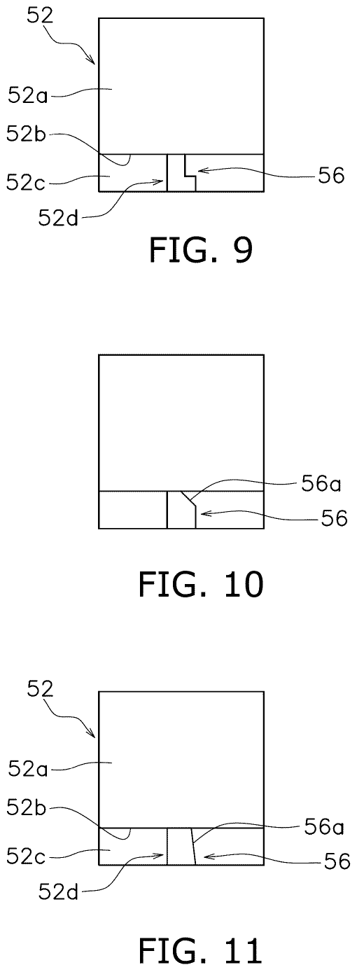

The shape of the protrusion 52d of the second flange 52 of the spool 42 may be changed. FIGS. 9 to 11 are diagrams illustrating modifications of the protrusion 52d. As illustrated in FIG. 9, the tip of the protrusion 52d may protrude toward the front. The protrusion 52d may protrude in a direction from the base end portion 76 to the distal portion 77 of the third tying portion 73a. In this case, movement of the lead wire of the coil 41 hooked on the protrusion 52d can be restricted.

As illustrated in FIGS. 10 and 11, the first surface 56 of the protrusion 52d may include an inclined surface 56a. The inclined surface 56a is inclined from the tip of the protrusion 52d toward the base end of the protrusion 52d in a direction approaching the rear surface of the protrusion 52d.

The order of connecting the lead wires of the coil 41 to the first through third tying portions 71a, 72a, and 73a may be changed. For example, one lead wire of the first winding of the coil 41 may first be tied to the third tying portion 73a, and then the winding is wound a predetermined amount counterclockwise around the body portion 53. Subsequently, the other lead wire of the first winding may be tied to the first tying portion 71a. One lead wire of the second winding of the coil 41 may be tied to the second tying portion 72a, and then the winding is wound a predetermined amount clockwise around the body portion 53. After that, the other lead wire of the second winding may be tied to the third tying portion 73a.

### REFERENCE NUMERALS

1: Electromagnetic relay, 41: Coil, 42: Spool, 52: Second flange (an example of flange), 52c: Terminal support portion, 52d: Protrusion, 53: Body portion, 71: First coil terminal, 71a: First tying portion, 72: Second coil terminal, 72a: Second tying portion, 73: Third coil terminal, 73a: Third tying portion, 76: Base end portion, 77: Distal portion, 80: Insulating wall

What is claimed is:

1. An electromagnet device, comprising:
a coil;
a spool including a body portion on which the coil is wound and a flange portion extending from the body portion;
a first coil terminal including a first tying portion extending from the flange portion in an axial direction of the body portion;
a second coil terminal including a second tying portion extending from the flange portion in the axial direction; and
a third coil terminal disposed between the first coil terminal and the second coil terminal, the third coil terminal including a third tying portion, the tying portion including a base end portion and a distal portion extending from the base end portion in a direction approaching the second tying portion,
the base end portion of the third tying portion being disposed eccentrically relative to an axis of the body portion in a direction from the second coil terminal toward the first coil terminal.

2. The electromagnet device according to claim 1, wherein
the third tying portion has a length dimension substantially equal to a length dimension of the first tying portion and a length dimension of the second tying portion.

3. The electromagnet device according to claim 1, wherein
the flange portion of the spool includes a terminal support portion configured to support the third coil terminal, and a protrusion facing the terminal support portion in the axial direction, and
the third tying portion of the third coil terminal is disposed between the terminal support portion and the protrusion.

4. The electromagnet device according to claim 1, wherein
a distance from the base end portion of the third tying portion to the first tying portion is substantially equal to the distance from a tip of the distal portion of the third tying portion to the second tying portion.

5. The electromagnet device according to claim 1, further comprising:
an insulating wall disposed at least one between the first tying portion and the third tying portion or between the second tying portion and the third tying portion.

6. The electromagnet device according to claim 1, wherein
the second coil terminal has the same shape as the first coil terminal, and
the third coil terminal is a terminal formed by bending a terminal having the same shape as the first coil terminal.
